(19) United States
(12) Patent Application Publication
(10) Pub. No.: US 2012/0141851 A1
(43) Pub. Date: Jun. 7, 2012

(54) SYSTEM AND METHOD FOR ENCLOSING AN ENERGY STORAGE DEVICE

(76) Inventors: Suyu Hou, Niskayuna, NY (US); Anthony Giammarise, Erie, PA (US); John Dowell, Grove City, PA (US); Roland Sedziol, Niskayuna, NY (US); Peter Kalish, Clifton Park, NY (US); Kristopher Frutschy, Clifton Park, NY (US); Neil Anthony Johnson, Schenectady, NY (US); David Vanderwerker, Schenectady, NY (US); George Hansen, Onalaska, WI (US)

(21) Appl. No.: 12/960,732

(22) Filed: Dec. 6, 2010

(51) Int. Cl. H01M 2/10

(52) U.S. Cl. 429/96; 29/623.2; 429/99

(57) ABSTRACT

An enclosure for an energy storage device is presently disclosed. The enclosure includes a cell housing having a base portion and at least one side portion seamlessly extending from the base portion to define a volume and having a peripheral edge defining an aperture distal from the base portion through which an electrochemical cell may be disposed within the volume, and a cover securable to the peripheral edge of the housing, where the housing and cover are configured to house at least one electrochemical cell at an operating temperature greater than about 100 degrees Celsius. The enclosure may also include an environmental housing configured to nestingly receive the cell housing, and an insulating element disposed between the environmental housing and the cell housing. Also disclosed is a method of packaging the energy storage device utilizing the enclosure.

### BACKGROUND

1. Technical Field

The subject matter disclosed herein relates to an enclosure for an energy storage device.

2. Discussion of Art

Energy storage devices may have challenges with leakage and manufacturability. Multiple welded seams may increase the number of discontinuities in the packaging, which may increase inefficient thermal management.

It may be desirable to have a battery package that differs from those packages that are currently available.

### BRIEF DESCRIPTION

Presently disclosed is an enclosure for an energy storage device. In an embodiment, the enclosure includes a cell housing having a base portion, and at least one side portion seamlessly extending from the base portion to define a volume and having a peripheral edge defining an aperture distal from the base portion through which an electrochemical cell may be disposed within the volume. A cover is securable to the peripheral edge of the cell housing over the aperture. The cell housing and cover are configured to house at least one electrochemical cell at an operating temperature that is greater than about 100 degrees Celsius.

A method to package an energy storage device is provided. In an embodiment, the method includes securing a cover to a peripheral edge of a cell housing having a base portion and at least one side portion seamlessly extending from the base portion, and placing the cell housing containing an electrochemical cell into an environmental housing volume through an aperture of the environmental housing.

An energy storage device is provided in one embodiment. The energy storage device includes a deep drawn monolithic housing defining a volume. The deep drawn monolithic housing has one or more corners, and at least one of the corners has a profile that is rounded. A cover engages the housing and at least partially encloses the volume. A plurality of electrochemical cells are disposed in the volume in an array configured to prevent any of the plurality of electrochemical cells from being disposed in the at least one corner with the rounded profile.

### BRIEF DESCRIPTION OF THE DRAWINGS

Reference is made to the accompanying drawings in which particular embodiments and further benefits of the invention are illustrated as described in more detail in the description below, in which:

FIG. 1 is a perspective view of an embodiment of an enclosure for an energy storage device;

FIG. 2 is a cross-section view of an embodiment of an enclosure for an energy storage device;

FIG. 3 is a perspective view of another embodiment of an enclosure for an energy storage device;

FIG. 4 is a cross-section view of another embodiment of an enclosure for an energy storage device;

FIG. 5 is a cross-sectional view of yet another embodiment of an enclosure for an energy storage device;

FIG. 6 is a perspective view of yet another embodiment of an enclosure for an energy storage device;

FIG. 7 is a cross-sectional view of another embodiment of an enclosure for an energy storage device;

FIG. 8 is a cross-section view of another embodiment of an enclosure for an energy storage device.

FIG. 9 is a perspective view of another embodiment of an enclosure for an energy storage device;

FIG. 10 is a cross-section view of another enclosure for an energy storage device;

FIG. 11 is a cross-section view of an embodiment of an enclosure for an energy storage device with mounting features;

FIG. 12 is a top view of another embodiment of an enclosure for an energy storage device with mounting features;

FIG. 13 is a top view of an embodiment of an energy storage device;

FIG. 14 is a top view of another embodiment of an energy storage device;

FIG. 15 is a schematic view of an embodiment of an enclosure for an energy storage device in a system; and

FIG. 16 is a perspective view of another embodiment of a partially assembled enclosure for an energy storage device.

### DETAILED DESCRIPTION

The subject matter disclosed herein relates to an enclosure for an energy storage device. Referring to FIGS. 1 through 16, embodiments of an enclosure for an energy storage device and a method for packaging an energy storage device are disclosed. The enclosure for an energy storage device may support a wide variety of electrochemical cells, such as sodium-halide, sodium-sulfur, lithium-sulfur, and other available electrochemical cells used for energy storage. In one embodiment, the electrochemical cells have an operating temperature determined by the melting point of the materials utilized in the cells. For example, the operating temperature may be greater than about 100 degrees Celsius, such as between 250 degrees Celsius and 400 degrees Celsius, or between 400 degrees Celsius and 700 degrees Celsius, but other desired operating temperatures are possible. In one embodiment, the operating temperature is between 250 and 350 degrees Celsius.

In an embodiment, the enclosure for an energy storage device includes a cell housing having a base portion, and at least one side portion seamlessly extending from the base portion to define a volume. The housing also has a peripheral edge defining an aperture distal from the base portion through which at least one electrochemical cell may be disposed within the volume. The aperture is configured to receive one or more electrochemical cells during assembly. The enclosure also includes a cover that is securable to the peripheral edge of the cell housing. The housing and cover are configured to house at least one electrochemical cell at an operating temperature that is greater than about 100 degrees Celsius. In some embodiments, the housing and cover are configured to house electrochemical cells operating at temperatures greater than about 250 degrees Celsius, or greater than about 400 degrees Celsius.

Referring now to FIG. 1, one embodiment of a cell housing 20 for use with an enclosure for an energy storage device is illustrated. As illustrated in FIG. 1, the cell housing 20 has a base portion 22 and side portions 24 seamlessly extending from the base portion. The housing has four side portions 24 defining a rectangular shape. The transition between the base portion 22 and the side portions 24 is rounded or curved as necessary to facilitate manufacturing of the housing. In some embodiments, the rounded or curved transition between the base portion 22 and the side portions 24 interferes with the placement of electrochemical cells 106 immediately adjacent to the side portions 24 of the housing, and a support, such as lateral support 108 illustrated in FIG. 10, is provided within the cell housing to provide lateral support to the electrochemical cells. In addition, various configurations of electrochemical cells may be utilized with the enclosure presently disclosed, with the selection based on application specific parameters. For example, the housing may be fully or partially loaded with electrochemical cells depending upon the requirements of a given application.

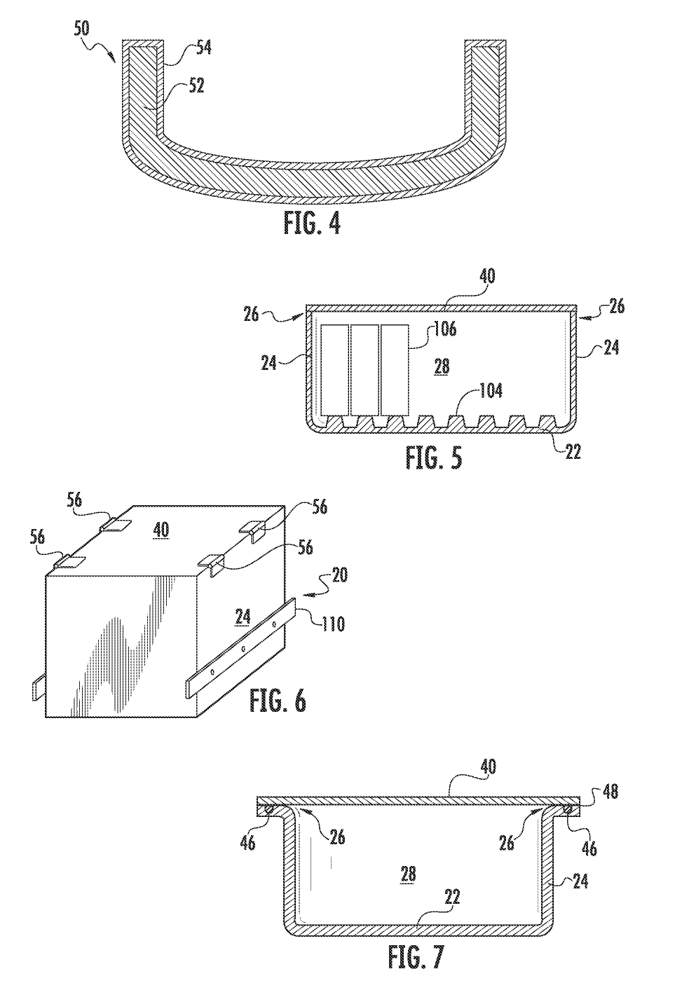

As illustrated, the side portions 24 extend upward from the base portion 22. The side portions may be substantially straight or may be curved or stepped as desired. In some embodiments, the environment in which the energy storage device will be used imposes restrictions on the dimensions of the enclosure and the housing is configured to accommodate these dimensions. The base portion 22 is substantially planar as illustrated, but other configurations are also contemplated. In an alternative embodiment, the base portion includes ridges or alignment features to facilitate the installation and/or support of the electrochemical cells within the housing. In an embodiment, the ridges are integrally formed with the base portion of the housing. In an alternative embodiment, the guides are attached to the housing, such as by welding on L-brackets. In another embodiment, a sump portion 104 is provided to elevate and position the electrochemical cells and provide a reservoir to receive electrolyte fluid in the event an electrochemical cell is damaged. As shown in FIG. 4, the sump portion is integrally formed with the base portion. In an alternative embodiment, the sump portion is a separately installable component such as an elevated and perforated panel.

In another embodiment, the housing 20 is provided with guides or rails to mate with the device or system with which the energy storage device will be used and to facilitate installation. For example, in one embodiment, rails 110 are attached to the side portions 24 of the housing 20 as illustrated in FIG. 5. In another embodiment, the base portion 22 may include cooling features to assist with regulating the temperature of the electrochemical cells within the housing.

The housing also has a peripheral edge 26 defining an aperture distal from the base portion 22 through which at least one electrochemical cell 106 may be disposed within the volume. The peripheral edge 26 is configured such that a cover (not shown in FIG. 1) may be secured to the peripheral edge 26 to enclose the at least one electrochemical cell 106 placed within the volume of the housing. Additionally, in some embodiments as will be described hereafter, the peripheral edge 26 includes a flange or other structure, extending outward from the side portion 24 to facilitate attachment of the cover and/or installation of the electrochemical cells. The peripheral edge 26 may be rounded or smoothed to remove rough or sharp edges to avoid damage to the electrochemical cells or injury to workers during assembly or maintenance operations.

In an embodiment, the cell housing 20 includes a base portion 22 and at least one side portion 24 extending seamlessly from the base portion 22 to define a volume 28. The term “seam” as used herein refers to a boundary or joint between two discrete pieces of material that are welded, bonded, or otherwise joined together. As such, the cell housing may be understood as having a continuous surface lacking in seams, joints or similar discontinuities in material between the base portion and the at least one side portion. In one embodiment, the cell housing is a seamless housing having a continuous surface lacking in seams, joints, or other discontinuities in material in the portion of the housing defining the volume.

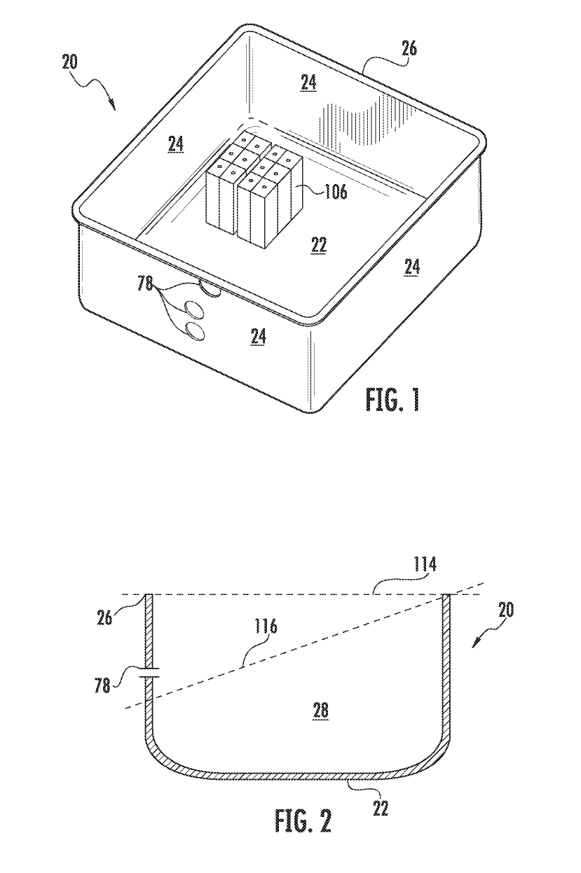

Referring to FIG. 2, a cross section of a cell housing is illustrated. In an embodiment, the cell housing 20 includes a base portion 22 and at least one side portion 24 extending seamlessly form the base portion to define a volume 28. The at least one side portion 24 defines a peripheral edge 26 that defines a first plane 114 illustrated by a dashed line in FIG. 2. In one embodiment, the cell housing is seamless in the entirety of the surface defining the volume 28 bounded by the first plane 114. In another embodiment, the cell housing is seamless in the surface defining the volume 28 bounded by the first plane 114 except for one or more openings 78 or ports. An opening or port is an aperture through the housing that is occupied by material, such as connectors or components other than the housing. The opening 78 is at least laterally surrounded by continuous material of the housing. The one or more openings 78 as discussed below provide access to the electrochemical cells disposed within the volume 28. The openings 78 may also provide pathways for cooling fluid. As such, the cell housing 20 is seamless in the entirety of the region encompassed by the plane 114 and volume 28 but for one or more ports.

In another alternative, the cell housing 20 is a seamless housing lacking boundaries or joints between discrete pieces of material that are welded, bonded, or otherwise joined together, where the discrete pieces of material are purposed for defining the volume 28 of the housing 20. As such, a seamless housing has a continuous surface lacking in discontinuities of joined sections of materials, but for possible discontinuities of other materials provided for purposes other than defining the volume of the cell housing. A port for an electrical connector is one example of a discontinuity provided for purposes other than defining the volume. The purpose of a port is to provide access to the interior region of the cell housing and not for defining the volume of the housing, even though the port may fill the opening 78 and therefore define the volume in an incidental sense. In another embodiment, an opening 78 may be filled with a plug of material that is removeable for installing a connector or other component.

In another embodiment, the cell housing 20 is a seamless housing lacking boundaries or joints between discrete pieces of material that are welded, bonded, or otherwise joined together, where the discrete pieces form a non-circumscribed junction. The openings 78 or ports described above are examples of circumscribed junctions, laterally surrounded by continuous material of the housing.

In yet another embodiment, the cell housing 20 includes a base portion 22 and at least one side portion 24 extending seamlessly from the base portion to define a volume 28, and the cell housing 20 is seamless in a region encompassing a portion of the volume 28 defined by a second plane 116 that intersects at least a portion of the peripheral edge 26 and at least one side portion 24. As illustrated, the portion of the cell housing 20 that defines a portion of the volume 28 defined by the second plane 116 is seamless, where the portion of the volume 28 is less than the entirety of the volume.

In another embodiment, the cell housing 20 includes a base 22 with a periphery; the periphery defines an area of the base. All or a portion of the base 22 may be planar. Around the entire periphery of the base, a peripheral side wall extends up from and is seamlessly attached to (e.g., integral with) the base portion. Additionally, around the entire periphery, the peripheral side wall is disposed at a non-zero degree angle to the base portion, and has a height (distance greater than zero). The peripheral side wall defines at least part of a volume 28 of the housing 20. In an embodiment, at least part of the peripheral side wall is disposed at a ninety degree angle to the base. In another embodiment, the entire portion of the base and side wall below the volume defined by the side wall is seamless.

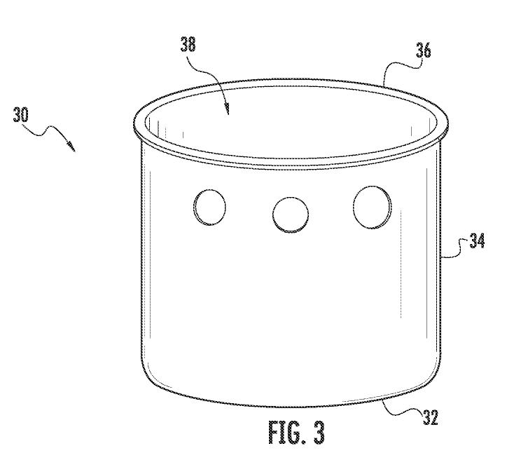

In various embodiments, the seamless housing is formed from sheet metal that is stamped, drawn, extruded, or pressed into the desired shape to form the housing without seams. In one embodiment, the cell housing is a deep drawn monolithic housing. A deep drawn housing is formed from material, such as a section of sheet metal, that is press formed one or more times to achieve the desired configuration. In one embodiment, press forming includes stamping a section of steel metal using a die to alter the shape of the metal. The resulting deep drawn housing retains the continuity of the original material avoiding the formation of seams or other discontinuities. A deep drawn housing is a monolithic structure consisting of a single unbroken component. After the housing is formed, one or more openings may be cut into the housing to accommodate ports. In an embodiment, a deep drawn monolithic housing is a seamless housing formed from one piece of material. A deep drawn housing may be provided in multiple configurations, such as the cell housing 20 illustrated in FIG. 1 and the cylindrical housing 30 illustrated in FIG. 3.

In various embodiments, the cell housing is formed of stainless steel, other corrosion resistant alloy, or other suitable material that can provide structural support at the operating temperature of the energy storage device. The material of the housing may be selected to avoid undesired reactions with the chemistry of the electrochemical cells in the event that an electrochemical cell is damaged or leaks within the enclosure. Other factors in the material selection include environmental conditions, operating conditions, electrical and thermal insulation factors, and other application specific parameters. In one embodiment, the housing is formed of non-metallic materials such as molded plastic or fiberglass. In each instance, the housing may be understood to form a continuous structure for housing the electrochemical cells disposed within the volume of the cell housing. Additionally, since seams, such as weld joints, have been known to degrade over time, the housing may provide improved reliability and resistance to breakage, leakage or other deterioration. Further, since weld joints may have discontinuities, there may result relatively short paths for thermal loss and management that are undesirable. The enclosure described herein may be useful in applications where the energy storage device is subjected to high temperature, vibration, or both.

The cell housing of the enclosure for an energy storage device may be formed in a variety of shapes and sizes to accommodate specific electrochemical cells. The energy storage capacity of an energy storage device is correlated to the number of electrochemical cells utilized in the device, and the enclosure may be sized to house one, two, or any number of electrochemical cells to achieve a desired energy storage capacity. Additionally, the enclosure may be adapted to mate with the shape or mounting features of an existing application. In this manner, the enclosure may be utilized with replacement energy storage devices with minimal impact to the system or device with which it is to be used.

In another embodiment, the housing for use with an enclosure for an energy storage device is a substantially cylindrical housing 30 as illustrated in FIG. 3. The cylindrical housing 30 includes a base portion 32 and a side portion 34 seamlessly extending from the base portion 32 to define a volume. The cylindrical housing has a peripheral edge 36 defining an aperture 38 distal from the base portion through which at least one electrochemical cell (not shown in FIG. 2) may be disposed within the volume. In an embodiment, the cylindrical housing 30 is formed from sheet metal stamped or pressed into the desired configuration, or from other metallic or non-metallic materials, to form a housing to enclose the at least one electrochemical cell. In an embodiment, the cylindrical housing 30 is a deep drawn monolithic housing formed from sheet metal drawn into a forming die by a punch or other tool. As illustrated in FIGS. 1 through 3, the side portions of the cell housing extend seamlessly from the base portion to eliminate the need for welds or other joints around the edges or corners of the base portion of the housing. In one embodiment, the side portions extending seamlessly from the base portion form a five sided housing to which a cover may be secured. In one embodiment, the transition between the base portion and the at least one side portion defines one or more corners, and at least one of the corners has a profile that is rounded. A rounded profile is a transition that has a radius of curvature and is not a 90-degree corner. In an embodiment, the radius of curvature of the transition between the base portion and the at least one side portion is greater than 0.25 inches. In another embodiment, the radius of curvature of the transition between the base portion and the at least one side portion is greater than 0.5 inches. The reduction in the number of welds may result in improved reliability for the enclosure and may reduce assembly time and costs for packaging an energy storage device.

Referring now to FIG. 3, a cross-section of an alternative embodiment of a cell housing for use with an enclosure for an energy storage device is illustrated. The housing is a composite housing 50 having a non-metallic core 52 capable of retaining structural integrity at the operating temperature of the energy storage device. In alternative embodiments, the non-metallic core 52 includes plastic, fiberglass, or other materials capable of providing structural support to the energy storage device at and above the operating temperature of the electrochemical cells. Alternatively or additionally, the non-metallic core 52 may be capable of providing at least some thermal insulation for the energy storage device. In one embodiment, a phase change material or other thermally insulative material is provided to facilitate the control of heat generated by the at least one electrochemical cell within the enclosure.

The non-metallic core 52 may or may not be adapted to prevent leakage from the energy storage device or prevent the ingress of air or moisture. In one embodiment, the composite housing 50 has a seamless outer layer 54 at least partially covering the non-metallic core 52. The outer layer 54 may be capable of inhibiting the ingress of air or moisture into the enclosure. In an embodiment, the non-metallic core 52 is formed with seams and the outer layer 54 is seamless such that the composite housing 50 is a seamless housing as described above. In another embodiment, the non-metallic core 52 is also seamless. As illustrated in FIG. 4, the outer layer 54 fully encloses the non-metallic core 52. In other embodiments, however, the seamless outer layer 54 partially covers the non-metallic core 52, such as on the portion of the surface of the non-metallic core that defines the volume of the cell housing.

In an embodiment, the composite housing 50 permits the selection of a first material for the non-metallic core 52 based upon the structural properties of the material, and permits the selection of a second material for the outer layer 54 based upon non-structural characteristics, such as the ability to inhibit the ingress of air or moisture into the enclosure. As such, the composite housing 50 may provide flexibility for certain applications of the enclosure.

Referring now to FIG. 5, a cross section of an enclosure for an energy storage device is illustrated with a cover 40 secured to a cell housing. When the cover 40 is secured to the peripheral edge 26 of the housing, the volume 28 of the housing is fully enclosed by the cover 40, base portion 22, and the at least one side portion 24. As such, a plurality of electrochemical cells 106 disposed within the volume 28 are fully enclosed and protected within the housing. In one embodiment, the electrochemical cells 106 are elevated by ridges forming the sump portion 104 such that electrolytic fluid may drain away from the cells if a cell is damaged or leaks.

The cover 40 may be secured to the peripheral edge 26 of the cell housing in a variety of methods. In one embodiment, the cover 40 is welded to the peripheral edge 26. The peripheral edge 26 may be configured to facilitate welding of the cover 40. In an embodiment, the peripheral edge 26 is weldable to the cover 40 to provide a single continuous seam securing the cover 40 to the housing. A single continuous weld seam may improve the reliability of the enclosure by reducing the number of welds and the number of discontinuities in the weld seam. A single continuous weld or full perimeter weld surface also may provide a longer path for thermal loss in the system. By reducing the number of weld seams, the opportunity for variation in weld quality is reduced increasing the likelihood of a high quality weld securing the cover 40 to the cell housing.

In other embodiments, the cover 40 is welded to the peripheral edge 26 of the housing by a weld process suitable to the materials selected for the cover and housing. In various embodiments, the weld seam is created by a laser weld process, a resistance weld process, an electron beam weld process, a plasma arc weld process, a tungsten inert gas weld process, a wire weld process, a solder weld process, or any other appropriate welding technique. Additionally, the connection between the cover 40 and the peripheral edge 26 of the housing may be any suitable weld joint geometry, such as butt joint, lap joint, corner joint, edge joint, or T-joint. The cover 40 may be welded to any portion of the peripheral edge 26 as desired to secure the cover to the housing. The peripheral edge 26 may thus be understood as the portion of the housing to which the cover 40 is secured. In some embodiments, the cover 40 is secured to a portion of the side portions 24 and this portion would also be properly understood as part of the peripheral edge 26 of the housing.

Referring now to FIG. 6, an alternative embodiment of an enclosure for an energy storage device is illustrated in which the cover 40 is secured to the cell housing 20 with fasteners 56. The enclosure includes at least one fastener 56 configured to secure the cover 40 to the housing 20. In the illustrated embodiment, four fasteners 56 secure the cover 40 to the housing 20. In one example, the fasteners 56 include angle brackets secured to the cover and housing by bolts or similar threaded connectors. In another embodiment, the cover 40 is secured to a side portion 24 of the housing by a hinge. In another embodiment, the cell housing 20 is provided with rails 110 configured to support the enclosure in an application. As illustrated, the rails 110 are attached to the side portions 24 and may facilitate installation of the energy storage device in a system.

In other embodiments, a combination of fasteners and welds are utilized. For example, the cover 40 may be secured to the housing by a hinge during the assembly of the energy storage device to prevent the cover 40 from being separated from the housing and to allow the cover 40 to be opened and closed during the assembly process. After the electrochemical cells are placed within the volume of the housing, the cover 40 may be secured to the peripheral edge of the housing by a weld as previously described.

In yet another embodiment, the enclosure for an energy storage device further includes a flange extending from the peripheral edge of the housing to support the cover. Referring to FIG. 7, the peripheral edge 26 of the housing includes a flange 46 extending outwardly from the aperture defined by the peripheral edge. The cover 40 is secured to the flange 46 of the peripheral edge using any of the methods previously described. For example, the cover 40 may be welded to the flange 46, may be secured with one or more fastener, or may be secured using combinations of welding and fasteners as desired.

The flange 46 may provide a larger surface to facilitate attachment of the cover 40, and may improve the ability to weld the cover 40 to the housing by providing increased access to the weld area. A single continuous weld or full perimeter weld surface also may provide a longer path for thermal loss in the system.

In one embodiment, the cover 40 is secured to the flange 46 by a lap weld. In another embodiment, a gasket 48 is disposed between the cover 40 and the housing. As illustrated in FIG. 7, the gasket 48 is disposed between the cover 40 and the flange 46. In other embodiments that may or may not include a flange, the gasket is positioned to extend substantially around the peripheral edge of the housing to form a seal when the cover is attached. The gasket 48 may be formed of material suitable for use at the operating temperature of the energy storage device. In an embodiment, the gasket 48 is formed of a silicon rubber capable of maintaining a seal at temperatures in excess of 100 degrees Celsius or in excess of 250 degrees Celsius.

As illustrated in FIGS. 5 through 7, the cover 40 and the base portion 22 are substantially planar, however, other configurations are also contemplated. In one alternative embodiment, the base portion 22 has a curvature that is either convex or concave by a determined amount. A concave base portion extends towards the aperture of the housing. In some embodiments, a concave base portion is biased into a substantially planer configuration by the weight of the electrochemical cells disposed within the housing. In another embodiment, the base portion is convex and extends away from the aperture of the housing. A convex base portion may be convex by a sufficient amount that a vacuum applied to the volume after the cover is secured to the housing biases the base portion from convex into a substantially planar configuration. A convex base portion is illustrated in FIG. 4. The vacuum may not be a total vacuum, but may be any reduced pressure applied to the volume.

In yet another alternative embodiment, the cover 40 has a curvature that is either convex or concave by a determined amount. A concave cover may extend towards the base portion of the housing. Alternatively, the cover may be convex and may extend away from the base portion of the housing. A convex cover may be convex by a sufficient amount that a vacuum applied to the volume after the cover is secured to the housing biases the cover from convex into a substantially planer configuration.

As described above, the base portion and cover may be formed to provide additional benefits or features to the enclosure. For example, the cover may have one or more raised portions to accommodate cables, connectors, or other components used in connection with the electrochemical cells of the energy storage device. In yet another embodiment, the cover is substantially similar to the housing, including a cover portion, side portions seamlessly extending from the cover portion, and a peripheral edge capable of being secured to the peripheral edge of the housing. Such an embodiment may substantially increase the size of the volume of the housing thereby increasing the capacity of the energy storage device by enabling the inclusion of a larger number of electrochemical cells.

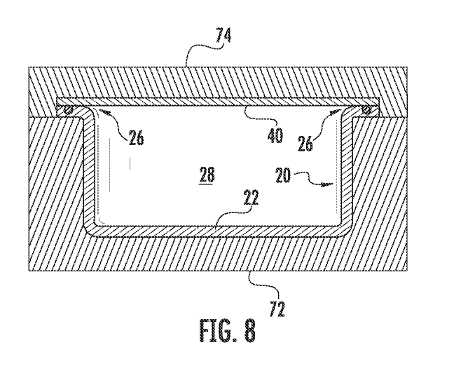

In another embodiment, the enclosure for an energy storage device includes a first insulation element 72 configured to nestingly receive the cell housing 20 as illustrated in FIG. 8. The enclosure also includes a second insulation element 74 configured to engage the first insulation element and be positioned adjacent to the cover 40. The first insulation element 72 and the second insulation element 74 provide thermal insulation for the energy storage device to assist in maintaining the operating temperature of the electrochemical cells in the desired range. In an embodiment, the first insulation element and second insulation element are formed as a single component of insulating material, such as an insulation fabric configured to be wrapped around the housing. In such an embodiment, the first insulation element is that portion of the insulating material that nestingly receives the housing, while the second insulation element is that portion of the insulating material that is positioned adjacent the cover.

Suitable insulating materials may be selected for use with the presently disclosed enclosure. In an embodiment, the first and second insulation elements are formed of the same insulating materials. In an alternative embodiment, the first and second insulation elements are formed of different materials. The insulation elements may be formed of one or more insulating materials, or combinations of material, to provide the desired amount of thermal insulation. In alternative embodiments, the insulation materials are foamed, woven, or non-woven insulation. In alternative embodiments, the insulation materials include zirconium, aluminum, magnesium, calcium-silicate, phase change materials or other suitable insulating materials or combinations of multiple materials.

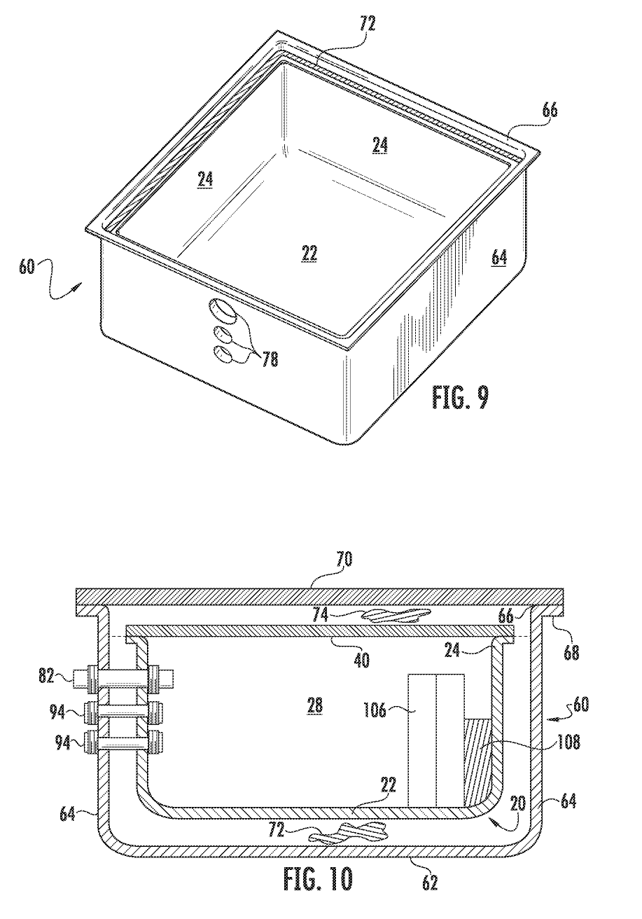

Referring now to FIGS. 9 and 10, another embodiment of the enclosure for an energy storage device is illustrated including inner cell housing and an outer environmental housing. The outer environmental housing 60 provides the interface between the enclosure and the operating environment in which the energy storage device is utilized. The environmental housing 60 has an environmental housing base portion 62 and at least one environmental housing side portion 64 extending from the environmental housing base portion to define an environmental housing volume. The at least one environmental housing side portion 64 has an environmental housing peripheral edge 66 defining an environmental housing aperture or top opening. The environmental housing 60 may also have an environmental housing flange 68 extending around the environmental housing peripheral edge 66. The environmental housing 60 is configured to nestingly receive the cell housing, such as housing 20, cylindrical housing 30, or composite housing 50. An environmental cover 70 is securable to the environmental housing 60 to cover the top opening of the environmental housing, and may be securable to the flange 68 extending around the peripheral edge 66 of the top opening.

As shown in FIG. 9, the cell housing is nestingly received in the environmental housing 60, such that the base portion 22 of the cell housing is disposed proximate to the base portion 62 of the environmental housing, and the side portions 24 of the housing are disposed proximate to the side portions 64 of the environmental housing 60.

The environmental housing may provide an external or outer housing of the enclosure for an energy storage device. In an embodiment, the environmental or outer housing is constructed in substantially the same fashion as described above in connection with the cell housing including the seamless transition between the base portion and the at least one side portions. In one embodiment, the environmental housing 60 is a deep drawn monolithic housing. In another embodiment, the environmental housing 60 is larger, but otherwise identical to the cell housing. In other embodiments, the environmental housing 60 has seams and is constructed of one or more discrete parts joined together by welds, fasteners, or other attachments.

In an embodiment, the environmental housing 60 inhibits the ingress of air and moisture into the enclosure. In some embodiments, the environmental housing 60 and the housing combine to render the enclosure about impervious to moisture or leakage. The environmental housing 60 also provides structural support for the enclosure. For example, the environmental housing 60 may provide rigidity to the enclosure for protecting the electrochemical cells from damage.

Referring now to FIG. 10, a cross section of an enclosure having both a cell housing 20 and an environmental housing 60 is illustrated. The cell housing has a base portion 22 and side portions 24, and a cover 40 secured to the cell housing as previously described. A plurality of electrochemical cells 106 are disposed within the cell housing. As shown, the transition between the base portion 22 and the side portion 24 of the cell housing 20 is rounded and interferes with the placement of electrochemical cells immediately adjacent the side portion 24. In an embodiment, a lateral support 108 is provided between the electrochemical cells 106 and the side portion 24 of the cell housing 20 to secure the electrochemical cells and inhibit movement within the cell housing. The environmental housing 60 has an environmental housing base portion 62 and environmental housing side portions 64 with an environmental housing flange 68 extending substantially around the environmental housing peripheral edge 66 of the top opening of the environmental housing. An environmental cover 70 is secured to the environmental housing flange 68 of the environmental housing 60 to cover the top opening of the environmental housing and fully enclose the electrochemical cells positioned within the volume 28 of the cell housing disposed within the environmental housing.

In some embodiments, the operating temperature of the electrochemical cells of the energy storage device is greater than 100 degrees Celsius. In one embodiment, an energy storage device utilizing a sodium-halide chemistry has an operating temperature between 250 degrees Celsius and 300 degrees Celsius. Alternatively, an energy storage device may have an operating temperature greater than 300 degrees Celsius, and in some embodiments, may have an operating temperature between 400 degrees Celsius and 700 degrees Celsius. Although energy storage devices have high internal operating temperatures, it may be desired to employ an energy storage device in an environment with a substantially lower ambient temperature.

In various embodiments, the enclosure for an energy storage device also includes at least one first insulation element 72 configured to nestingly receive the cell housing 20, and a second insulation element 74 configured to engage the first insulation element and be positioned adjacent to the cover 40. In one embodiment, the housing is enveloped by the first insulation element 72 and the second insulation element 74 prior to installation in an environmental housing. As illustrated in FIG. 10, the first insulation element 72 is disposed in the region between the side portions and base portions of the environmental housing 60 and the cell housing 20. The second insulation element 74 is disposed in the region between the environmental cover 70 and the cover 40. The first insulation element 72 engages the second insulation element 74 to envelop the cell housing and cover to provide thermal insulation for the enclosure. In another embodiment, at least one insulation element is disposed between the housing and the environmental housing, where the insulation element is configured to envelop the housing.

In another embodiment, the enclosure includes the first insulation element nestingly receiving the cell housing and the second insulation element, without the use of an environmental housing, such as illustrated in FIG. 8. For example, in some applications an existing receptacle or container may be adapted to receive the energy storage device and a separate environmental housing may not be desired. The insulation element may be provided with the cell housing or integrated with the existing receptacle or container to provide thermal insulation for the energy storage device.

In another embodiment, the enclosure for an energy storage device includes a vacuum between the environmental housing and the cell housing to provide thermal insulation. A vacuum applied to the space between the environmental housing and the cell housing may increase the thermal resistance of the enclosure thereby reducing the transfer of heat from the enclosure to the surrounding environment. In one embodiment, after the environmental cover is secured to the environmental housing, a negative pressure may be applied to a sealable aperture in a side portion of the environmental housing to establish a vacuum or reduced pressure within the enclosure.

The enclosure for an energy storage device may also include one or more openings configured to provide access to the volume of the housing and the electrochemical cells disposed within the enclosure. In one embodiment, the enclosure for an energy storage device includes a sealable port extending from the exterior of the enclosure through at least one side portion and into the volume of the cell housing to provide external electrical access to the at least one electrochemical cell disposed within the housing. In one embodiment, the sealable port provides an airtight seal between the side portions of the environmental housing and the housing to maintain a vacuum or reduced pressure between the environmental housing and cell housing as previously discussed. The sealable port may also be adapted to provide an electrical connection pathway to the at least one electrochemical cell disposed within the housing, such as by installing an electrical connector in the sealable port. In another embodiment, the sealable port is hermetically sealed and a hermetically sealed electrical connector provides the electrical pathway. In an embodiment, the connector is selected to reduce the ingress of air or moisture that could interfere with the operation of the energy storage device, and is selected to accommodate the electrical current and voltage to be produced by the energy storage device.

Referring again to FIG. 10, a sealable port 82 is illustrated extending through the side portion 64 of the environmental housing 60, through a first insulating material 72, and through the side portion 24 of the cell housing 20 into the volume 28. Also illustrated are inlet port 92 and outlet port 94 that are fluidically coupled to an internal region of the enclosure as discussed below. As shown in FIG. 9, the environmental housing 60 and cell housing have one or more openings 78 formed in the side portions of the housings. In an embodiment, three openings 78 are provided. In an embodiment, the cell housing is a seamless housing and the openings 78 are at least laterally surrounded by continuous material of the side portion of the cell housing as illustrated in FIGS. 1 and 3. The openings 78 may be different sizes as desired to accommodate the one or more ports to provide electrical access, or to accommodate other connectors or pathways.

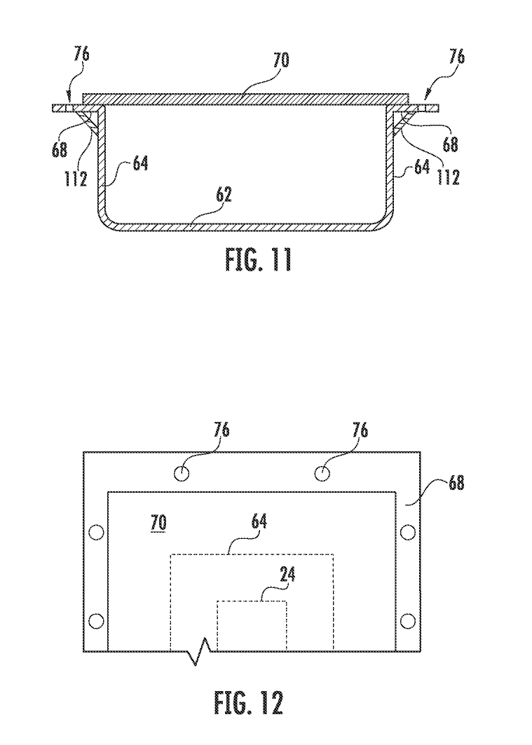

Referring now to FIGS. 11 and 12, in an embodiment, the environmental housing 60 also includes mounting apertures 76 and the environmental housing flange 68 is formed with sufficient strength to support the weight of the fully assembled energy storage device. In one embodiment, the environmental housing flange 68 of the environmental housing 60 is provided with mounting apertures 76 positioned outside of the environmental cover 70, such that the energy storage device may be mounted in a desired location using the mounting apertures. As shown in FIG. 12, a plurality of mounting apertures 76 are provided in the environmental housing flange 68. The flange of the cell housing may be provided with similar mounting apertures for mounting the cell housing in applications without an environmental housing. The mounting apertures illustrated may accommodate bolts or other suitable fasteners, however, more complex mounting systems may be utilized as desired. The flange may be further adapted to support the weight of the energy storage device. For example, supplemental supports 112 may be provided to brace the flange 68 to the side portions 64 of the environmental housing to increase the load bearing capacity of the flange. In another alternative, the flange 68 is formed into a structural shape, such as an angle, to increase its load bearing capacity.

In addition, when the environmental housing 60 is secured to a system or other device by the flange 68, the flange 68 may provide an effective pathway for thermal loss or electrical grounding of the enclosure. In various embodiments, the flange 68 may be smaller or larger as desired and may be sized and configured to meet the requirements of a given installation or application.

One or more electrochemical cells may be disposed within the enclosure presently disclosed to form an energy storage device. In an embodiment, an electrical storage device includes a cell housing nestingly received in an environmental housing with an insulating material disposed between the cell housing and the environmental housing. The orientation of the electrochemical cells disposed within the volume of the cell housing may be varied as desired. In one embodiment, an array of electrochemical cells is provided in the cell housing. The array of electrochemical cells may be connected in series or parallel as necessary to provide the desired current and voltage for a given application.

To facilitate installation and maintenance, the electrochemical cells may be disposed within the housing such that the electrical connections of the electrochemical cells are accessible when the cover is removed. However, the orientation of the electrochemical cells disposed within the volume of the housing is not restricted and the arrangement of the electrochemical cells may be tailored for specific applications.

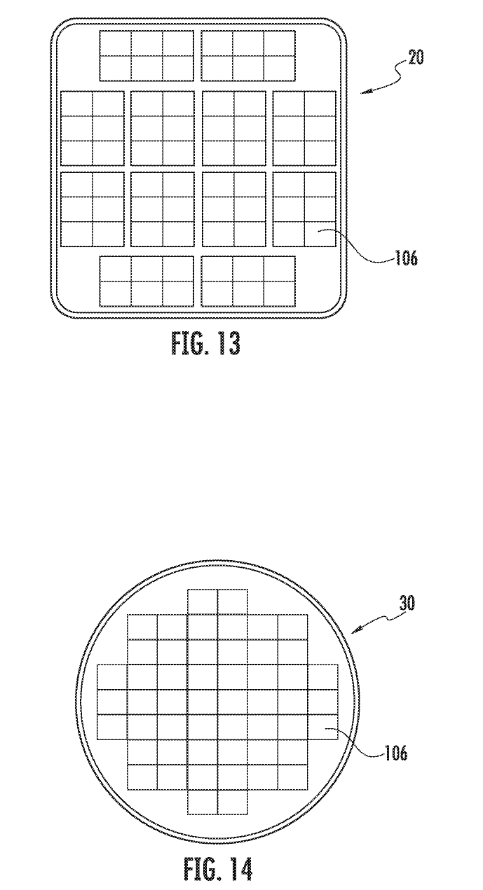

In another embodiment, the plurality of electrochemical cells are disposed in the volume of the cell housing in an array configured to prevent any of the plurality of electrochemical cells from being disposed in the at least one corner with a rounded profile. As previously discussed, the transition between the base portion 22 and the at least one side portion 24 of the cell housing 20 may have a rounded profile or corner that interferes with the placement of electrochemical cells immediately adjacent the side portion 24. In other embodiments, transitions between the at least one side portions 24 have a rounded profile that interferes with the placement of electrochemical cells. As shown in FIG. 13, the electrochemical cells 106 are disposed in the cell housing 20 such that the electrochemical cells are not disposed in the corners of the cell housing having a rounded profile. One or more internal supports, such as the lateral support 108 illustrated in FIG. 10, may be provided to support the electrochemical cells and at least partially fill the portion of the volume not occupied by electrochemical cells. In one embodiment, the electrochemical cells 106 may be arranged in groups as illustrated in FIG. 13. In another embodiment, the electrochemical cells 106 are disposed in a cylindrical housing 30 in an array configured to prevent any of the plurality of electrochemical cells from being disposed immediately adjacent to the curved side portions of the housing as shown in FIG. 14.

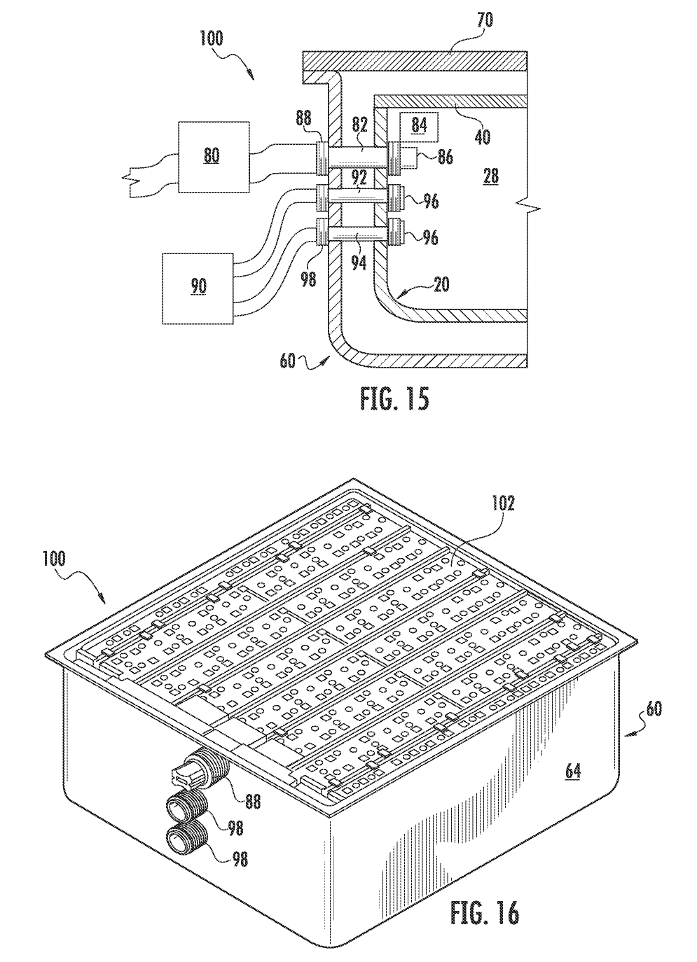

Referring now to FIG. 15, an energy storage device 100 is illustrated having an inner cell housing 20 received within an outer environmental housing 60. The energy storage device 100 includes at least one electrochemical cell (not shown in FIG. 11) disposed within the volume 28 of the cell housing. The energy storage device 100 also includes a controller 80. In an embodiment, the controller 80 is disposed outside of the volume 28 of the cell housing and is operable to control the operation of the electrochemical cells disposed within the enclosure. In another embodiment, the energy storage device 100 includes at least one sensor 84 disposed in or proximate to the enclosure. The sensor 84 may be in communication with the controller and operable to monitor at least one condition or parameter of the electrochemical cells. As illustrated, the sealed port 82 includes a hermetically sealed connector providing an internal connector 86 and an external connector 88. The internal connector 86, illustrated as a threaded electrical connector, is configured to connect to the electrochemical cells disposed within the enclosure. The external connector 88 is configured to connect to the controller 80, or alternatively to a cable or other electrical pathway connected to the controller 80. In other embodiments, the output power connection and the control/signal connections are divided into separate connectors, however, reducing the number of connectors passing through the side portions of the enclosure may improve the reliability of the energy storage device.

In an embodiment, the controller is in communication with the sensor, and the sensor is further capable of monitoring one or more conditions or parameters of the electrochemical cells in the energy storage device and communicating information related to the monitored conditions to the controller. For example, the sensor may be capable of detecting the charge level of the electrochemical cells and identifying a low power condition when the power output of the electrochemical cells is depleted. Similarly, for a rechargeable system, the sensor may be capable of reporting a full charge condition allowing the controller to discontinue charging the electrochemical cells to avoid potential damage or degradation of the cells. In some embodiments, the controller and sensor are co-located, or one device may provide both the sensing and controlling capability for the energy storage device.

In another embodiment, the enclosure for an energy storage device includes an inlet port 92 that fluidically couples an internal region of the enclosure to an external source of heat transfer fluid such as a cooling fluid, an outlet port 94 fluidically coupled to the internal region of the enclosure which allows emission of a fluid from the internal region of the enclosure, and a displacement unit 90 fluidically coupled to the inlet port which pushes the fluid through the inlet port into the internal region of the enclosure through the outlet port and out of the enclosure. The inlet port 92 and outlet port 94 include inner connectors 96 and outer connectors 98. In an embodiment, the inner connectors 96 may be connected to pipes within the enclosure adapted to absorb heat from the electrochemical cells. The outer connectors 98 are connected to the displacement unit 90 as shown, or may be connected to other external plumbing as desired. In one embodiment, displacement unit 90 dissipates excess heat and the heat transfer fluid remains in a closed system circulating through the enclosure of the energy storage device.

In an embodiment, the displacement unit 90 is controlled by a temperature regulation system configured to monitor and control the operating temperature of the energy storage device within a predetermined temperature range. In another embodiment, the energy storage device includes a heating system disposed within the enclosure configured to raise the temperature of the electrochemical cells to the desired operating temperature. In one embodiment, the internal operating temperature of the energy storage device is maintained between approximately 200 degrees Celsius and 300 degrees Celsius. In one embodiment, the sensor 84 is further capable of detecting the temperature of the electrochemical cells within the enclosure and communicating the monitored temperature to the controller 80. The controller 80 may implement a temperature regulation system by controlling the operation of a heating system and the displacement unit 90 to heat or cool the electrochemical cells as required to maintain the desired operating temperature.

Referring now to FIG. 16, a partially assembled energy storage device 100 is illustrated. The energy storage device 100 is shown prior to installation of the cover or environmental cover according to the specific embodiment of the enclosure. An array of electrochemical cells is disposed within the cell housing, which is nestingly received in the environmental housing 60 with an insulating material disposed between the environmental housing and the cell housing. The external connector 88 provides the electrical connection to the electrochemical cells within the enclosure, and the outer connectors 98 of the inlet and outlet ports of a temperature regulation system are illustrated. In an embodiment, the energy storage device 100 includes circuitry 102 disposed within the enclosure. The circuitry 102 may be provided to monitor, control, or route the electrical output of the electrochemical cells. In addition, the circuitry 102 may regulate the output power of the energy storage device within specified parameters of current and voltage or provide other desired control operations. Also disclosed is a method of packaging an energy storage device. The method includes providing a cell housing having a base portion and at least one side portion seamlessly extending from the base portion to define a volume and having a peripheral edge defining an aperture distal from the base portion. The method further includes providing an environmental housing having an environmental housing base portion and at least one environmental housing side portion extending from the environmental housing base portion to define an environmental housing volume and having an environmental housing peripheral edge defining an environmental housing aperture distal from the environmental housing base portion. In an embodiment, the method includes placing the cell housing into the volume of the environmental housing, placing at least one electrochemical cell into the cell housing, securing a cover to the peripheral edge of the cell housing, and securing an environmental cover to the environmental housing peripheral edge. The cell housing may be placed into the environmental housing such that the base portion of the environmental housing is proximate the base portion of the cell housing, however other orientations are possible. The method may also include providing a first insulation element within the environmental housing to nestingly receive the cell housing, and providing a second insulation element that is configured to engage the first insulation element. The method of packaging an energy storage device may improve the reliability of energy storage device and reduce the time and cost of assembling an energy storage device.

In another embodiment, the enclosure for an energy storage device includes a cell housing and a cover. The cell housing has a base portion, and at least one side portion extending from the base portion to define a volume. The side portion has a peripheral edge defining an aperture distal from the base portion through which at least one electrochemical cell may be disposed within the volume. The cover is securable to the peripheral edge of the cell housing. The housing and cover are configured to house the at least one electrochemical cell at an operating temperature equal to or greater than approximate 100 degrees Celsius. “Approximate” a given value of degrees Celsius (e.g., 100 degrees Celsius) means +/−2% of the given value. In another embodiment, the housing and cover are configured to house the at least one electrochemical cell at an operating temperature at or above 100 degrees Celsius. In another embodiment, the housing and cover are configured to house the at least one electrochemical cell at an operating temperature that is above 200 degrees Celsius.

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not different from the literal language of the claims, or if they include equivalent structural elements with insubstantial differences from the literal language of the claims.

What is claimed is:

1. An enclosure for an energy storage device, comprising:
a cell housing having a base portion, and at least one side portion seamlessly extending from the base portion to define a volume and having a peripheral edge defining an aperture distal from the base portion through which at least one electrochemical cell may be disposed within the volume; and
a cover that is securable to the peripheral edge of the cell housing, where the cell housing and cover are configured to house the at least one electrochemical cell at an operating temperature that is greater than about 100 degrees Celsius.

2. The enclosure according to claim 1 wherein the cell housing peripheral edge is weldable to the cover to provide a single continuous weld seam securing the cover to the cell housing peripheral edge.

3. The enclosure according to claim 2 wherein the weld seam is created by one or more of a laser weld process, a resistance weld process, an electron beam weld process, a plasma arc weld process, a tungsten inert gas weld process, a wire weld process, and a solder weld process.

4. The enclosure according to claim 1 further comprising at least one fastener that is configured to secure the cover to the cell housing.

5. The enclosure according to claim 1 further comprising a flange extending from the peripheral edge of the cell housing to support the cover.

6. The enclosure according to claim 1 wherein the cell housing has a non-metallic core capable of retaining structural integrity at the operating temperature.

7. The enclosure according to claim 1 wherein the base portion of the cell housing is convex.

8. The enclosure according to claim 7 wherein the degree of convexity of the base portion is selected based on a degree of vacuum to be obtained in a space defined by an outer surface of the base portion and an inward facing surface of an environmental housing, and thereby to urge the base portion from a convex to a planar configuration upon application of the vacuum.

9. The enclosure according to claim 1 further comprising:
at least one first insulation element that is configured to nestingly receive the cell housing; and
a second insulation element that is configured to engage the first insulation element and be positioned adjacent to the cover.

10. The enclosure according to claim 9 wherein the first and second insulation elements are formed from the same or different material that is foamed, woven, or non-woven, and comprise one or more material selected from the group consisting of zirconium, aluminum, magnesium, and calcium-silicate.

11. The enclosure according to claim 1 further comprising:
an environmental housing having an environmental housing base portion and at least one environmental housing side portion extending from the environmental housing base portion to define an environmental housing volume and having an environmental housing peripheral edge defining an environmental housing aperture with an environmental housing flange extending from the environmental housing peripheral edge, where the environmental housing is configured to nestingly receive the cell housing; and
an environmental cover that is securable to the environmental housing to cover the environmental housing aperture.

12. The enclosure according to claim 11 further comprising at least one insulation element disposed between the cell housing and the environmental housing, where the insulation element is configured to envelop the cell housing.

13. The enclosure according to claim 11 further comprising a sealable port extending from external the enclosure through the side portions and into the cell housing volume to provide external electrical access to the at least one electrochemical cell disposed within the cell housing.

14. The enclosure according to claim 13 wherein the sealable port is hermetically sealed and provides an electrical connection pathway to the at least one electrochemical cell disposed within the cell housing.

15. The enclosure according to claim 1 further comprising:
an inlet port that fluidically couples an internal region of the enclosure to an external source of heat transfer fluid;
an outlet port, fluidically coupled to the internal region of the enclosure, which allows emission of the fluid from the internal region of the enclosure; and
a displacement unit fluidically coupled to the inlet port, which pushes the fluid through the inlet port, into the internal region of the enclosure, through the outlet port, and out of the enclosure.

16. The enclosure according to claim 1 further comprising a gasket disposable between the cover and the cell housing.

17. The enclosure according to claim 1 wherein the cell housing is a deep drawn monolithic structure.

18. The enclosure according to claim 1 wherein the cell housing further comprises a sump portion.

19. A method to package an energy storage device comprising:
securing a cover to a peripheral edge of a cell housing having a base portion and at least one side portion seamlessly extending from the base portion, and
placing the cell housing containing an electrochemical cell into a volume of an environmental housing through an aperture of the environmental housing.

20. An energy storage device, comprising:
a deep drawn monolithic housing defining a volume and defining one or more corners, at least one of the corners having a profile that is rounded;
a cover configured to engage the deep drawn monolithic housing and at least partially enclose the volume; and
a plurality of electrochemical cells disposed in the volume in an array configured to prevent any of the plurality of electrochemical cells from being disposed in the at least one corner with the rounded profile.
